(19) United States
(12) Patent Application Publication
(10) Pub. No.: US 2026/0244496 A1
(43) Pub. Date: Aug. 20, 2026

(54) MEMORY EXPANSION METHOD AND APPARATUS, SERVER SYSTEM, ELECTRONIC DEVICE, AND STORAGE MEDIUM

(71) Applicant: IEIT SYSTEMS (BEIJING) CO., LTD, Beijing (CN)

(72) Inventors: Jiaheng FAN, Beijing (CN); Yanwei WANG, Beijing (CN); Cheng HUANG, Beijing (CN); Junkai LIU, Beijing (CN)

(21) Appl. No.: 19/469,597

(22) PCT Filed: Nov. 22, 2024
(86) PCT No.: PCT/CN2024/133955

§ 371 Date: Sep. 26, 2025

(30) Foreign Application Priority Data
Nov. 23, 2023 (CN) 202311572671.0

(51) Int. Cl. G06F 9/50

(52) U.S. Cl. CPC G06F 9/5016

(57) ABSTRACT

Disclosed are a memory expansion method and apparatus, a server system, an electronic device, and a storage medium, relating to the technical field of computers. The server system includes servers and a memory server. The servers include a main server and sub-servers, and the memory server includes a switch and memory expansion devices. The plurality of memory expansion devices and the plurality of servers are connected to the switch, and the memory expansion device includes an expanded memory. The memory expansion method includes: receiving a memory application request from the sub-server; determining a target memory expansion device among the plurality of memory expansion devices based on a requested memory size in the memory application request; and sending resource information of the target memory expansion device to the sub-server to enable the sub-server to use an expanded memory in the target memory expansion device.

expansion device does not correspond to a fixed server any more.

It should be understood that the above general description and the later detailed description are only exemplary, and may not limit the present application.

### BRIEF DESCRIPTION OF THE DRAWINGS

In order to describe the technical solutions in the embodiments of the present application or in the related art more clearly, the drawings required to be used in the embodiments or in the related art will be simply introduced below. It is apparent that the drawings described below are only some embodiments of the present application. Other drawings may further be obtained by those of ordinary skill in the art according to these drawings without creative work. The drawings are to provide further understanding of the present application and constitute a part of the present disclosure. The drawings, together with the implementations below, are used for explaining the present application and do not constitute limitations to the present application. In the drawings:

FIG. 1 is an architectural diagram of a server system in the related art;

FIG. 2 is an architectural diagram of a server system according to exemplary embodiments;

FIG. 3 is an architectural diagram of another server system according to exemplary embodiments;

FIG. 4 is a flowchart of a memory expansion method according to exemplary embodiments;

FIG. 5 is an architectural diagram of yet another server system according to exemplary embodiments;

FIG. 6 is a flowchart of another memory expansion method according to exemplary embodiments;

FIG. 7 is a structural diagram of a memory expansion apparatus according to exemplary embodiments;

FIG. 8 is a structural diagram of another memory expansion apparatus according to exemplary embodiments; and

FIG. 9 is a structural diagram of an electronic device shown according to exemplary embodiments.

### DETAILED DESCRIPTION

The technical solutions in the embodiments of the present application will be clearly and completely described below with reference to the drawings in the embodiments of the present application. Apparently, the described embodiments are not all embodiments but only part of the embodiments of the present application. All other embodiments obtained by those of ordinary skill in the art based on the embodiments in the present application without creative work shall fall within the scope of protection of the present application. In addition, the terms “first”, “second”, etc. in the embodiments of the present application are used to distinguish similar objects rather than describe a sequence.

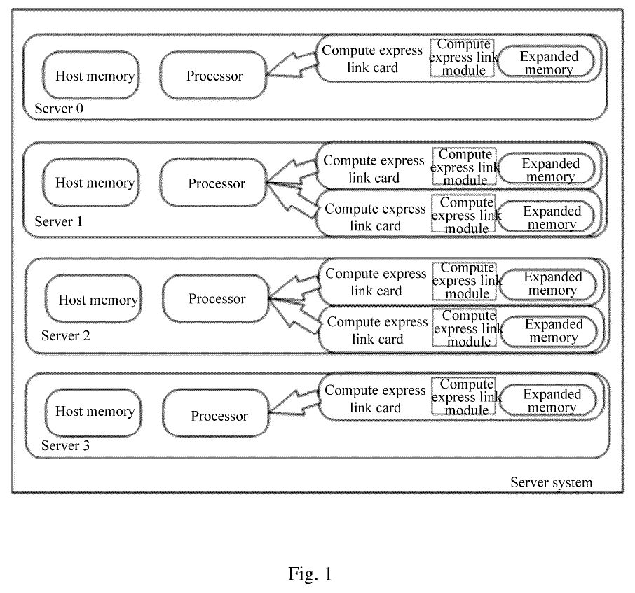

Compute express link (CXL) is a high-performance and low-latency interconnection technology and configured to connect processors, accelerators, and memory devices. A CXL Type 3 device is a set of memory modules to provide persistent, volatile, or combined memory. An architectural diagram of a server system in the related art is shown as FIG. 1. Servers in the system expand memory according to requirements of application scenarios. For example, a single CXL board may expand 64G memory, a server 0 needs to expand 64G memory according to an application scenario, and one CXL board is inserted into the server 0. A server 1 needs to expand 96G memory according to an application scenario, and two CXL boards are inserted into the server 1. Following this principle, corresponding CXL boards are inserted into a corresponding server according to requirements of the server.

After the CXL board is inserted into the server, the board is configured to a Type3 mode, and an expanded memory generates a new non-uniform memory access (numa) node, whereby a host program may use the expanded memory. For example, local memory of the server 0 is a numa 0 node, and is expanded through one CXL board to form a new numa 1 node. Local memory of the server 1 is a numa 1 node, and is expanded through two CXL boards to form new numa 1 and numa 2 nodes. After formation of new numa nodes, the host program of the corresponding server may operate using the expanded memory.

This method for expanding memory in a mode of inserting the CXL board into the server lacks flexibility of use, application scenarios of the servers are constantly changing, the required memory is also variable, but the memory capacity expanded by the single CXL board is fixed and may not meet ever-changing memory demands of the servers. For example, the single CXL board may expand the 64G memory, a server needs to expand 64G memory according to an application scenario 1, and one CXL board is inserted to meet the requirement. When the server needs to expand 128G memory according to an application scenario 2, two CXL boards are required to be inserted to meet the requirement. In this case, the application scenario of the server is switched back to the application scenario 1, it means that one CXL board is needed, and the other CXL board inserted into the server is wasted, thereby causing resource waste. For another example, the single CXL board may expand 64G memory, the server needs to expand 32G memory according to the application scenario 1, one CXL board is inserted, and a 32G expanded memory is wasted. When the server needs to expand 96G memory according to the application scenario 2, two CXL boards are required to be inserted, and a 32G expanded memory is also wasted. This usage mode also causes resource waste.

Therefore, in the present application, a memory server is additionally arranged in the server system and includes a switch and a plurality of memory expansion devices. The plurality of memory expansion devices are connected to the servers in the server system through the switch and allocated through a main server, and each memory expansion device does not correspond to a fixed server any more, thereby meeting ever-changing memory demands of the servers, and improving memory expansion flexibility of the servers.

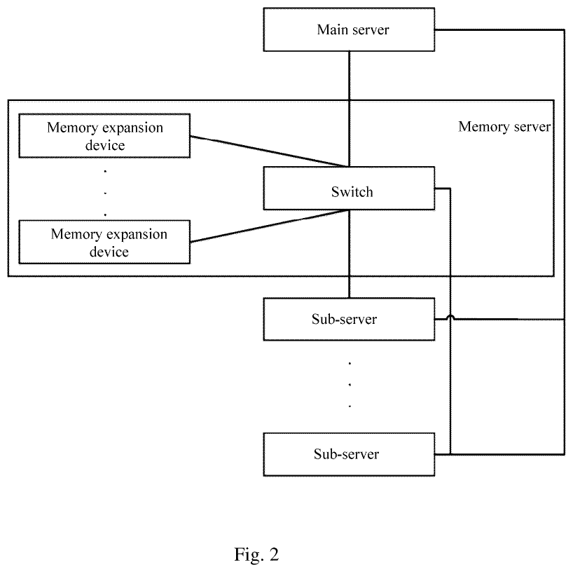

Some embodiments of the present application provide a server system, as shown in FIG. 2, which includes a plurality of servers and a memory server. The servers include a main server and a plurality of sub-servers. The plurality of servers are connected to the memory server, and the memory server includes a switch and a plurality of memory expansion devices. The plurality of memory expansion devices and the plurality of servers are connected to the switch, and the memory expansion device includes an expanded memory.

The server system may be understood as a set of the plurality of servers. In the embodiments, the memory server is additionally arranged in the server system, that is, the server system in the embodiments includes the plurality of servers and the memory server. The memory server includes the switch and the plurality of memory expansion devices. Each memory expansion device is connected to the switch, and each server is connected to each memory expansion device through the switch. The memory expansion device is configured to provide an expanded memory for the server. A main server is included in the servers. The main server and the plurality of sub-servers are connected through network ports, and the main server is configured to allocate and reclaim the expanded memory provided by the memory expansion device. This enables flexible supply of the expanded memory from the memory expansion device to the servers.

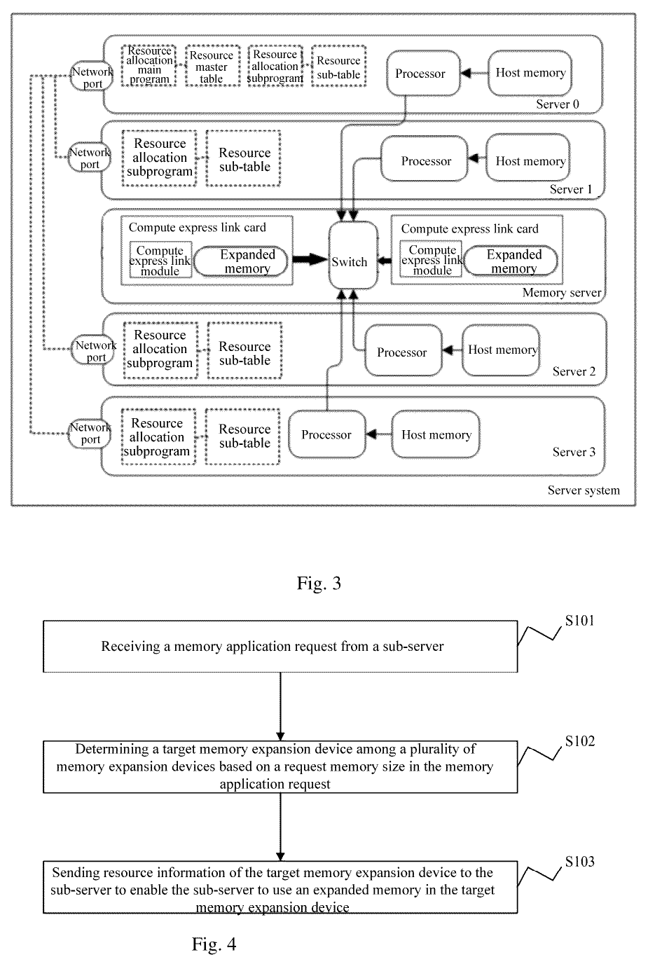

The memory expansion devices in the embodiments may be CXL devices, and, of course, may also be other types of memory expansion devices. This is not specifically defined herein. By taking a CXL device as the memory expansion device as an example for illustration, an architectural diagram of the server system is shown as FIG. 3, and the memory server in the server system includes CXL boards and a CXL switch, and the CXL boards are connected to the servers in the system through the CXL switch. The servers are connected through a network to exchange information. The memory server may be placed in the middle of the system, to reduce a distance of a connecting cable between the server and the memory server, thereby reducing latency of accessing the CXL boards.

A server in the system plays a role of the main server, a resource allocation main program running on the server scans all devices in the memory server, records parameters of the CXL boards, creates a device resource master table based on information of the CXL boards, and fills the information of the CXL boards in the device resource master table. When an application program of a server needs memory expansion, a resource allocation subprogram running on the server sends a CXL board resource request message to the resource allocation main program on the main server. In this case, the resource allocation main program on the main server receives the message from the resource allocation subprogram, retrieves an unused CXL board from the device resource master table, and sends information on this CXL board to the resource allocation subprogram, whereby the resource allocation subprogram creates a device resource sub-table locally to maintain the information on this CXL board, and the application program calls the information on this CXL board from the device resource sub-table, uses this board, and creates a local new numa node for use. When the application program of this server does not need this CXL board for memory expansion any more, the resource allocation subprogram removes this CXL board from a local device resource sub-table, and resends CXL board release information to the resource allocation main program, and the resource allocation main program receives device resource release information and refills this CXL board in the device resource master table, to complete updating of the device resource master table. In this way, a process of requesting and releasing the CXL board is completed.

Embodiments of the present application provides a memory expansion method, to improve memory expansion flexibility of servers.

FIG. 4 is a flowchart of a memory expansion method according to exemplary embodiments, and as shown in FIG. 4, the method includes:

S101: Receiving a memory application request from a sub-server.

An execution entity of the embodiments is the main server in the above server system. As some implementations, before the receiving a memory application request from a sub-server, the method further includes: scanning a memory server to acquire resource information of all memory expansion devices in the memory server; and creating a resource master table, and adding the resource information of all the memory expansion devices to the resource master table. In some implementations, a resource allocation main program of the main server scans the memory server to acquire the resource information of all the memory expansion devices, creates the resource master table, and writes the resource information of all the memory expansion devices into the resource master table. An example of the resource master table is shown as Table 1:

TABLE 1

| | |
|---|---|
| CXL board 0 | 64 G |
| CXL board 1 | 64 G |
| CXL board 2 | 128 G |
| CXL board 3 | 128 G |
| CXL board 4 | 256 G |
| CXL board 5 | 256 G |

The resource allocation main program of the main server waits for the memory application request sent by a resource allocation subprogram of the sub-server. When the sub-server needs memory expansion, the resource allocation subprogram in the sub-server sends the memory application request to the resource allocation main program of the main server, the memory application request at least including a to-be-requested memory size, and waits for feedback from the resource allocation main program. It should be noted that when the main server needs to request memory expansion, a resource allocation subprogram in the main server is also required to send a memory application request to the resource allocation main program.

S102: Determining a target memory expansion device among a plurality of memory expansion devices based on a requested memory size in the memory application request.

In some implementations, the resource allocation main program of the main server determines the target memory expansion device among the plurality of memory expansion devices based on the requested memory size in the memory application request and the resource master table, and allocates an expanded memory with a corresponding size to the sub-server. The memory expansion devices in the embodiments may be CXL devices, and, of course, may also be other types of memory expansion devices. This is not specifically defined herein.

S103: Sending resource information of the target memory expansion device to the sub-server to enable the sub-server to use an expanded memory in the target memory expansion device.

In some implementations, the resource allocation main program of the main server deletes the resource information of the target memory expansion device from the resource master table, and sends the resource information of the target memory expansion device to the sub-server through a network port between the main server and the sub-server. The resource allocation subprogram of the sub-server, after receiving the resource information of the target memory expansion device sent by the resource allocation main program, creates a local resource sub-table, and fills the resource information of the target memory expansion device in the sub-table. An example of the resource sub-table is shown as Table 2:

TABLE 2

| | |
|---|---|
| CXL board 0 | 64 G |

The resource allocation subprogram of the sub-server manages the target memory expansion device, enables its memory expansion function, and creates a local new numa node to complete memory expansion of a local server. In this case, an application program of the sub-server may normally use the expanded memory.

Based on the embodiments, as some implementations, after the sending resource information of the target memory expansion device to the sub-server to enable the sub-server to use an expanded memory in the target memory expansion device, the method further includes: receiving a memory release request for releasing the target expansion device from the sub-server, and re-adding the resource information of the target memory expansion device to the resource master table.

In some implementations, after completing its work, the application program of the sub-server notifies the resource allocation subprogram that usage of the target memory expansion device is finished, and the resource allocation subprogram removes the resource information of the target memory expansion device from the device resource sub-table, and sends a message to the resource allocation main program to notify that the usage of the target memory expansion device is finished. The resource allocation main program of the main server, after receiving a resource reclamation message, refills the resource information of the target memory expansion device in the resource master table, replies a message that the target memory expansion device has been reclaimed to the resource allocation subprogram, and updates the device resource master table, and the resource allocation subprogram of the sub-sever receives feedback from the resource allocation main program.

In the embodiments of the present application, the memory server is additionally arranged in the server system and includes a switch and the plurality of memory expansion devices. The plurality of memory expansion devices are connected to the servers in the server system through the switch and allocated through the main server, and each memory expansion device does not correspond to a fixed server any more, thereby meeting ever-changing memory demands of the servers, and improving memory expansion flexibility of the servers.

Based on the above embodiments, as some implementations, the expanded memory includes a plurality of memory blocks with preset sizes. The determining a target memory expansion device among a plurality of memory expansion devices based on a requested memory size in the memory application request includes: determining a target memory block in the target memory expansion device based on the requested memory size in the memory application request.

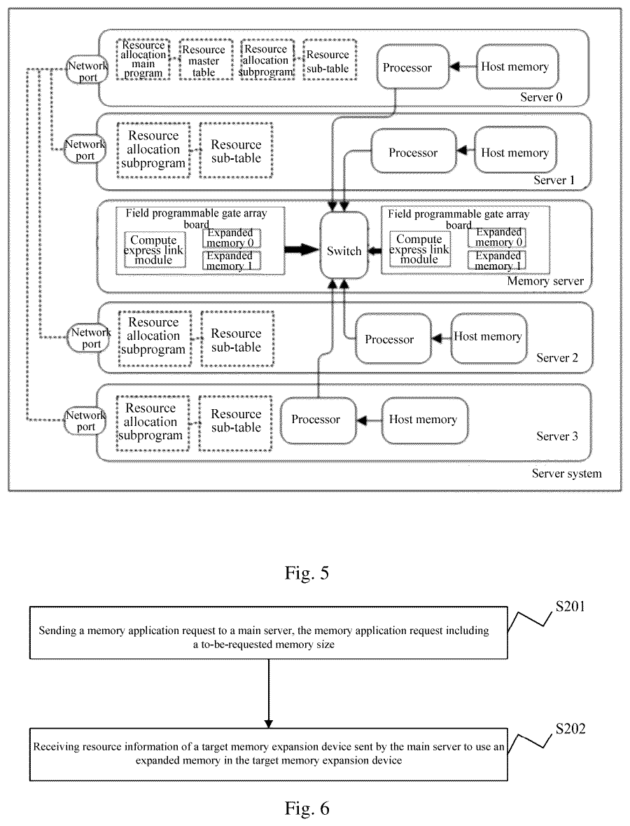

In some implementations, the memory expansion devices may, through a field programmable gate array (FPGA) board, achieve, for example, a CXL function. As shown in FIG. 5, a CXL logic module is implemented in the FPGA board first, and a cxl type 3 memory expansion mode is supported. It supports memory types such as a multi-channel random access memory (RAM) and a persistent memory (PMEM), facilitating application options of a user. Based on the preset sizes, the expanded memory is partitioned into the plurality of memory blocks, and the preset sizes may be flexibly set according to user requirements, such as 32G. Upon completion of region partitioning, access permissions are configured according to the user requirements. This permission logic is implemented by the FPGA, which determines an access right to a region according to a server device node making a request. Upon completion of allocation, resource information of these memory blocks is written into the resource master table, and configured to request memory expansion of the servers. An expanded memory 0 and an expanded memory 1 in FIG. 5 are different memory blocks. The main server may flexibly allocate expanded memories in a level of memory blocks, that is, the main server may allocate different memory blocks in the same memory expansion device to different sub-servers, to further improve the memory expansion flexibility of the servers.

The resource allocation main program of the main server determines a target memory block in the target memory expansion device based on the requested memory size in the memory application request and the resource master table, and allocates an expanded memory with a corresponding size to the sub-server. The resource allocation main program of the main server deletes the resource information of the target memory expansion device from the resource master table, and sends resource information of the target memory block in the target memory expansion device to the sub-server. The resource allocation subprogram of the sub-server adds the received resource information of the target memory block in the target memory expansion device to a locally created resource sub-table to use the target memory block in the target memory expansion device.

Based on the above embodiments, as some implementations, the memory expansion devices include expanded memories of different memory types. The memory expansion devices of each type including a plurality of memory blocks with preset sizes. The determining a target memory expansion device from a plurality of memory expansion devices based on a requested memory size in the memory application request includes: determining a target memory block in the target memory expansion device based on the requested memory size and a requested memory type in the memory application request.

In some implementations, the memory expansion devices may support expanded memories of different memory types, such as a random access memory (RAM) and a persistent memory (PMEM), and expanded memories of different memory types may also be partitioned into a plurality of memory blocks according to preset sizes. Exemplarily, a CXL memory expansion card of a FPGA has a 128G RAM and a 256G PMEM, and according to default block memory sizes, the RAM is partitioned into 4 blocks, namely a Region0-Ram, a Region1-Ram, a Region2-Ram, and a Region3-Ram respectively. The PMEM is partitioned into 8 blocks, namely a Regino0-Pmem, Regino1-Pmem, a Regino2-Pmem, a Regino3-Pmem, a Regino4-Pmem, a Regino5-Pmem, a Regino6-Pmem, and a Regino7-Pmem respectively. When a sub-server 1 requests for a 32G RAM, the main server allocates the Region0-Ram to the sub-server 1. When a sub-server 2 requests for a 64G RAM, the main server allocates the Region1-Ram and Region2-Ram to the sub-server 2. Following this principle, corresponding allocation is performed.

The resource allocation main program of the server determines the target memory block in the target memory expansion device based on the requested memory size and the requested memory type in the memory application request and the resource master table, and allocates an expanded memory with a corresponding size to the sub-server. The resource allocation main program of the server deletes the resource information of the target memory expansion device from the resource master table, and sends resource information of the target memory block in the target memory expansion device to the sub-server. The resource allocation subprogram of the sub-server adds the received resource information of the target memory block in the target memory expansion device to a locally created resource sub-table to use the target memory block in the target memory expansion device.

An example of the resource master table is shown as Table 3:

TABLE 3

| | | | | | | | |
|---|---|---|---|---|---|---|---|
| Clx0 | Reg0- | Reg1- | Reg0- | Reg1- | Reg2- | Reg3- | Reg4- |
| Ram = | ram | ram | Pmem | Pmem | Pmem | Pmem | Pmem |
| 64 G | | | | | | | |
| Pmem = | | | | | | | |
| 160 G | | | | | | | |
| Clx1 | Reg0- | Reg1- | Reg2- | Reg0- | Reg1- | Reg2- | Reg3- |
| Ram = | ram | ram | ram | Pmem | Pmem | Pmem | Pmem |
| 96 G | | | | | | | |
| Pmem = | | | | | | | |
| 128 G | | | | | | | |

An example of the resource sub-table is shown as Table 4:

TABLE 4

| | | | | | | | |
|---|---|---|---|---|---|---|---|
| Clx0 | Reg0- | Reg1- | Reg0- | Reg1- | Reg2- | Reg3- | Reg4- |
| Ram = | ram | ram | Pmem | Pmem | Pmem | Pmem | Pmem |
| 64 G | | | | | | | |
| Pmem = | | | | | | | |
| 160G | | | | | | | |

It may be seen that in the embodiments, the expanded memory of the memory expansion device may be partitioned into the plurality of memory blocks according to a minimum unit, thereby providing more precise memory regions and corresponding memory sizes for the user. A single memory expansion device may provide more precise memory regions according to user requirements, and supports a plurality of users to simultaneously use different regions of the same board, thereby improving an allocation efficiency of the board.

The embodiments of the present application discloses a memory expansion method. FIG. 6 is a flowchart of another memory expansion method according to exemplary embodiments, and as shown in FIG. 6, the method includes:

S201: Sending a memory application request to a main server, the memory application request including a to-be-requested memory size.

An execution entity of the embodiments is the sub-server in the above server system. In some implementations, when the sub-server needs memory expansion, a resource allocation subprogram in the sub-server sends the memory application request to a resource allocation main program of the main server, the memory application request at least including the to-be-requested memory size, and waits for feedback from the resource allocation main program.

S202: Receiving resource information of a target memory expansion device sent by the main server to use an expanded memory in the target memory expansion device.

In some implementations, the resource allocation main program of the main server determines the target memory expansion device among a plurality of memory expansion devices based on the requested memory size in the memory application request and a resource master table, and allocates an expanded memory with a corresponding size to the sub-server. The resource allocation main program of the main server deletes the resource information of the target memory expansion device from the resource master table, and sends the resource information of the target memory expansion device to the sub-server through a network port between the main server and the sub-server.

As some feasible implementations, the using an expanded memory in the target memory expansion device includes: creating a resource sub-table, and adding the resource information of the target memory expansion device to the resource sub-table; and creating a non-uniform memory access node based on the resource information of the target memory expansion device to use the expanded memory in the target memory expansion device. In some implementations, the resource allocation subprogram of the sub-server, after receiving the resource information of the target memory expansion device sent by the resource allocation main program, creates a local resource sub-table, and fills the resource information of the target memory expansion device in the resource sub-table. The resource allocation subprogram of the sub-server manages the target memory expansion device, enables its memory expansion function, and creates a local new numa node to complete memory expansion of a local server. In this case, an application program of the sub-server may normally use the expanded memory.

Based on the embodiments, as some implementations, after the receiving resource information of a target memory expansion device sent by the main server to use an expanded memory in the target memory expansion device, the method further includes: after the expanded memory in the target memory expansion device is used, sending a memory release request for releasing the target expansion device to the main server.

In some implementations, after completing its work, the application program of the sub-server notifies the resource allocation subprogram that usage of the target memory expansion device is finished, and the resource allocation subprogram deletes the resource information of the target memory expansion device from a device resource sub-table, sends a message to the resource allocation main program to notify that the usage of the target memory expansion device is finished. The resource allocation main program of the main server, after receiving a resource reclamation message, refills the resource information of the target memory expansion device in the resource master table, replies a message that the target memory expansion device has been reclaimed to the resource allocation subprogram, and updates a device resource master table, and the resource allocation subprogram of the sub-sever receives feedback from the resource allocation main program.

Based on the above embodiments, as some implementations, the receiving resource information of a target memory expansion device sent by the main server to use an expanded memory in the target memory expansion device includes: receiving resource information of a target memory block in the target memory expansion device sent by the main server to use the target memory block in the target memory expansion device.

In some implementations, the resource allocation main program of the main server determines the target memory block in the target memory expansion device based on the requested memory size in the memory application request and the resource master table, and allocates an expanded memory with a corresponding size to the sub-server. The resource allocation main program of the server deletes the resource information of the target memory expansion device from the resource master table, and sends the resource information of the target memory block in the target memory expansion device to the sub-server. The resource allocation subprogram of the sub-server adds the received resource information of the target memory block in the target memory expansion device to a locally created resource sub-table to use the target memory block in the target memory expansion device.

Based on the above embodiments, as some implementations, the memory application request further includes a to-be-requested memory type. The receiving resource information of a target memory expansion device sent by the main server to use an expanded memory in the target memory expansion device includes: receiving resource information of a target memory block matching the memory type in the target memory expansion device sent by the main server to use the target memory block in the target memory expansion device.

In some implementations, the resource allocation main program of the main server determines the target memory block in the target memory expansion device based on the requested memory size and the requested memory type in the memory application request and the resource master table, and allocates an expanded memory with a corresponding size to the sub-server. The resource allocation main program of the main server deletes the resource information of the target memory expansion device from the resource master table, and sends the resource information of the target memory block in the target memory expansion device to the sub-server. The resource allocation subprogram of the sub-server adds the received resource information of the target memory block in the target memory expansion device to a locally created resource sub-table to use the target memory block in the target memory expansion device.

Some application embodiments provided by the present application is introduced below, and includes the following steps:

Step 1: A resource allocation main program of a server 0 scans a memory server to acquire all cxl board resource information:

device_num = scan_cxl_devices( );
cx10_attr = scan_cxl_device(cx10);
cx11_attr = scan_cxl_device(cxl1).

Step 2: The resource allocation main program of the server 0 creates a device resource master table, and writes all the cxl board information into the device resource master table:

creat_table(cx10_attr,cxl1_attr,....).

Step 3: The resource allocation main program of the server 0 waits for cxl board request messages from other servers, and when the server 0 needs to request a cxl board, a device resource allocation subprogram on the server 0 is also required to initiate a request message to a device resource main program of a local machine:

wait_msg( ).

Step 4: An application program of a server 1 needs memory expansion, and a resource allocation subprogram on the local machine sends a to-be-requested memory size to the resource allocation main program of the server 0 through a network link, and waits for feedback from the resource allocation main program.

ram_size = get_app_ram_size( );
send_msg(ram_size);
wait_msg( ).

Step 5: The resource allocation main program of the server 0, after receiving a memory expansion request message from the resource allocation subprogram of the server 1, sends information on a cxl board with a corresponding size to the resource allocation subprogram based on the requested memory size and the cxl board information in the device resource master table, and removes this cxl board from the device resource master table:

cx10 = Get_device_from_table(ram_size);
send_msg(cx10);
update_table(cx10).

Step 6: The resource allocation subprogram of the server 1, after receiving cxl0 board information sent by the resource allocation main program, creates a local device resource sub-table, fills the cxl0 board information in the local device resource sub-table, manages a cxl0 board, enables its memory expansion function, and creates a local new numa node to complete memory expansion of a local server; and in this case, the application program may normally use the expanded memory:

create_table( );
add_device_to_table(cx10);
enable_device(cx10).

Step 7: After completing its work, the application program of the server 1 notifies the resource allocation subprogram that usage of the cxl0 board is finished. The resource allocation subprogram removes the cxl0 board from the device resource sub-table, and sends a message to the resource allocation main program to notify that the usage of the cxl0 board is finished:

remove_device_from_table(cx10);
send_msg(cx10).

Step 8: The resource allocation main program of the server 0, after receiving a resource reclamation message, refills the cxl0 board in the device resource master table, replies a message that the cxl0 board has been reclaimed to the resource allocation subprogram, and updates the device resource master table:

free_device_to_table(cx10);
send_msg(cx10);
update_table(cx10).

Step 9: The resource allocation subprogram of the server 1, after receiving the feedback from the resource allocation main program, completes an entire workflow. A memory expansion apparatus provided by some embodiments of the present application is introduced below, and the memory expansion apparatus described below and the memory expansion method described above may be mutually referenced.

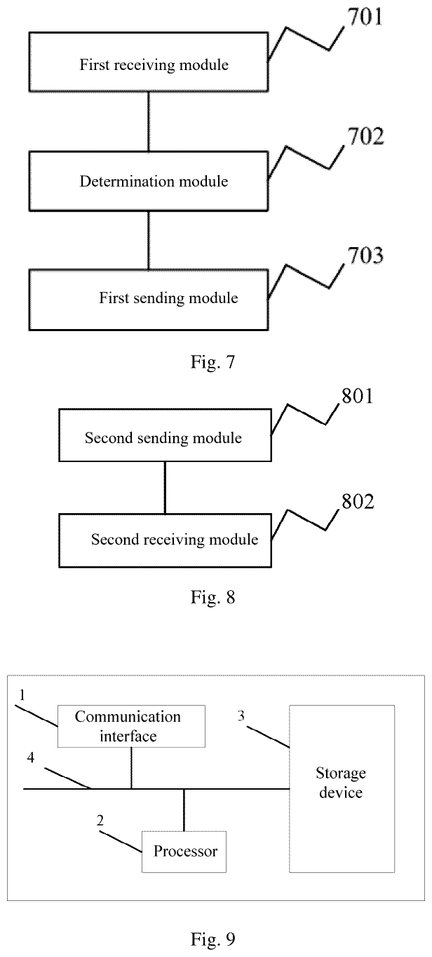

FIG. 7 is a structural diagram of a memory expansion apparatus according to exemplary embodiments, and as shown in FIG. 7, the memory expansion apparatus includes:
a first receiving module 701, configured to receive a memory application request from a sub-server;
a determination module 702, configured to determine a target memory expansion device among a plurality of memory expansion devices based on a requested memory size in the memory application request; and
a first sending module 703, configured to send resource information of the target memory expansion device to the sub-server to enable the sub-server to use an expanded memory in the target memory expansion device.

An execution entity of the embodiments is a main server of a server system. A memory server is additionally arranged in the server system in the embodiments of the present application and includes a switch and the plurality of memory expansion devices. The plurality of memory expansion devices are connected to servers in the server system through the switch and allocated through the main server, and each memory expansion device does not correspond to a fixed server any more, thereby meeting ever-changing memory demands of the servers, and improving memory expansion flexibility of the servers.

Based on the above embodiments, as some implementations, the memory expansion apparatus further includes:
a scanning module, configured to scan the memory server to acquire resource information of all memory expansion devices in the memory server; and
an adding module, configured to create a resource master table and add the resource information of all the memory expansion devices to the resource master table.

Based on the above embodiments, as some implementations, the determination module 702 is configured to: determine the target memory expansion device among the plurality of memory expansion devices based on the requested memory size in the memory application request and the resource master table.

Based on the above embodiments, as some implementations, the memory expansion apparatus further includes:
a first deletion module, configured to delete the resource information of the target memory expansion device from the resource master table.

Based on the above embodiments, as some implementations, the memory expansion apparatus further includes:
a third receiving module, configured to receive a memory release request for releasing the target expansion device from the sub-server, and re-add the resource information of the target memory expansion device to the resource master table.

Based on the above embodiments, as some implementations, the expanded memory includes a plurality of memory blocks with preset sizes, and the determination module 702 is configured to: determine a target memory block in the target memory expansion device based on the requested memory size in the memory application request.

Based on the above embodiments, as some implementations, the first sending module 703 is configured to: send resource information of the target memory block in the target memory expansion device to the sub-server to enable the sub-server to use the target memory block in the target memory expansion device.

Based on the above embodiments, as some implementations, the memory expansion devices include expanded memories of different memory types, with each type including a plurality of memory blocks with preset sizes, and the determination module 702 is configured to: determine a target memory block in the target memory expansion device based on the requested memory size and a requested memory type in the memory application request.

Based on the above embodiments, as some implementations, the first sending module 703 is configured to: send resource information of the target memory block in the target memory expansion device to the sub-server to enable the sub-server to use the target memory block in the target memory expansion device.

Based on the above embodiments, as some implementations, the main server is connected to a plurality of sub-servers through network ports, and the first sending module 703 is configured to: send resource information of the target memory expansion device to the sub-server through a network port between the main server and the sub-server.

Based on the above embodiments, as some implementations, the memory expansion device includes a compute express link device.

Another memory expansion apparatus provided by some embodiments of the present application is introduced below, and the memory expansion apparatus described below and another memory expansion method described above may be mutually referenced.

FIG. 8 is a structural diagram of another memory expansion apparatus according to exemplary embodiments, and as shown in FIG. 8, the apparatus includes:
a second sending module 801, configured to send a memory application request to a main server, the memory application request including a to-be-requested memory size; and
a second receiving module 802, configured to receive resource information of a target memory expansion device sent by the main server to use an expanded memory in the target memory expansion device.

An execution entity in the embodiments is the sub-server in the above server system.

Based on the above embodiments, as some implementations, the second receiving module 802 is configured to: receive resource information of a target memory expansion device sent by the main server, create a resource sub-table, and add the resource information of the target memory expansion device to the resource sub-table; and create a non-uniform memory access node based on the resource information of the target memory expansion device to use the expanded memory in the target memory expansion device.

Based on the above embodiments, as some implementations, the apparatus further includes:
a third sending module, configured to send a memory release request for releasing the target memory expansion device to the main server after the expanded memory in the target memory expansion device is used.

Based on the above embodiments, as some implementations, the apparatus further includes:
a second deletion module, configured to delete the resource information of the target memory expansion device from a local resource sub-table.

Based on the above embodiments, as some implementations, the second receiving module 802 is configured to: receive resource information of a target memory block in the target memory expansion device sent by the main server to use the target memory block in the target memory expansion device.

Based on the above embodiments, as some implementations, the memory application request further includes a to-be-requested memory type, and the second receiving module 802 is configured to: receive resource information of a target memory block matching the memory type in the target memory expansion device sent by the main server to use the target memory block in the target memory expansion device.

For the apparatus in the above embodiments, modes of implementing operations by modules have been described in detail in the embodiments related to the method, and this is not elaborated herein.

Based on hardware implementation of the above program modules, and to implement the methods described in the embodiments of the present application, some embodiments of the present application also provides an electronic device. FIG. 9 is a structural diagram of an electronic device according to exemplary embodiments, and as shown in FIG. 9, the electronic device includes:
a communication interface 1, capable of exchanging information with other devices such as a network device; and
a processor 2, connected to the communication interface 1 to exchange information with other devices, and configured to implement the memory expansion method provided by the above one or more technical solutions when running computer programs. The computer programs are stored in a storage device 3.

Of course, in practical application, components in the electronic device are coupled together through a bus system 4. It may be understood that the bus system 4 is configured to implement connection and communication between these components. The bus system 4 includes a data bus, and further includes a power bus, a control bus, and a status signal bus. However, for clear description, various buses are marked as the bus system 4 in FIG. 9.

The storage device 3 in the embodiments of the present application is configured to store various types of data to support operations of the electronic device. The data, for example, includes: any computer programs operating on the electronic device.

It may be understood that the storage device 3 may be a volatile storage device or a nonvolatile storage device, and may also include both the volatile storage device and the nonvolatile storage device. The nonvolatile storage device may be a read only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, an optical disk, or a compact disc read-only memory (CD-ROM); and the magnetic surface memory may be a magnetic disk storage or magnetic tape storage. The volatile storage device may be a random access memory (RAM), which serves as an external cache. For exemplary but nonrestrictive illustration, various forms of RAMs may be used, such as a static random access memory (SRAM), a synchronous static random access memory (SSRAM), a dynamic random access memory (DRAM), a synchronous dynamic random access memory (SDRAM), a double data rate synchronous dynamic random access memory (DDRSDRAM), an enhanced synchronous dynamic random access memory (EESDRAM), a synclink dynamic random access memory (SLDRAM), and a direct rambus random access memory (DRRAM). The storage device 3 described in the embodiments of the present application includes but not limited to these and any other suitable types of memories.

The methods disclosed in the above embodiments of the present application may be applied in the processor 2, or implemented by the processor 2. The processor 2 may be an integrated circuit with a signal processing capacity. During implementation, steps of the above methods may be completed by an integrated logic circuit in a hardware form, or instructions in a software form, in the processor 2. The above processor 2 may be a general-purpose processor, a digital signal processor (DSP), other programmable logic devices, a discrete gate, a transistor logic device, a discrete hardware component, etc. The processor 2 may implement or execute the methods, steps, and logic block diagrams disclosed in the embodiments of the present application. The general-purpose processor may be a microprocessor or any conventional processor. The steps in the methods disclosed by the embodiments of the present application may be directly implemented by hardware, namely a decoding processor, or implemented by combination of the hardware-decoding processor and software modules. The software modules may be located in a nonvolatile readable storage medium, the nonvolatile readable storage medium is located in the storage device 3, and the processor 2 reads programs in the storage device 3 and is combined with its hardware to complete the steps of the above methods.

When the processor 2 executes programs, it implements corresponding steps of the methods in the embodiments of the present application. For concision, this is not described in detail herein.

Exemplarily, some embodiments of the present application also provides a nonvolatile readable storage medium, which is a nonvolatile computer-readable storage medium, such as a storage device 3 storing computer programs, and the computer programs may be executed by a processor 2, to complete steps of the above methods. The nonvolatile computer-readable storage medium may be a FRAM, a ROM, a PROM, an EPROM, an EEPROM, a flash memory, a magnetic surface memory, an optical disk, a CD-ROM, and the like.

Those of ordinary skill in the art may understand that all or part of steps in the above method embodiments may be implemented by hardware related to program instructions, the above program may be stored in a nonvolatile computer-readable storage medium, and when the program is executed, the steps in the above method embodiments are implemented; and the above nonvolatile readable storage medium includes various media storing program codes, such as a portable storage device, a ROM, a RAM, a magnetic disk, and an optical disk.

In some embodiments, if the above integrated units in the present application are implemented in a form of software functional modules and sold or used as standalone products, they may also be stored in a nonvolatile computer-readable storage medium. Based on such understanding, the technical solutions of the present application—in their essence, the portion contributing to the related art—may be embodied in a form of a software product. This computer software product is stored in a nonvolatile readable storage medium and includes a plurality of instructions to enable an electronic device (that may be a personal computer, a server, a network device, etc.) to implement all or part of the methods in the embodiments of the present application. The above nonvolatile readable storage medium includes various media storing program codes, such as a portable storage device, a ROM, a RAM, a magnetic disk, an optical disk, etc.

The above is merely implementations of the present application, but is not intended to limit the scope of protection of the present application. Changes or replacements made by those of skill in the art within the technical scope disclosed by the present application shall fall within the scope of protection of the present application. Therefore, the scope of protection of the present application should be subject to the claims.

1. A memory expansion method, being applied to a main server in a server system, the server system comprising a plurality of servers and a memory server; the plurality of servers comprising the main server and a plurality of sub-servers, the memory server comprising a switch and a plurality of memory expansion devices, the plurality of memory expansion devices being connected to the switch, the plurality of servers being connected to the switch, the plurality of memory expansion devices comprising expanded-memories; and
the method comprising:
receiving a memory application request from a sub-server of the plurality of sub-servers;
determining a target memory expansion device among the plurality of memory expansion devices based on a requested memory size in the memory application request; and
sending resource information of the target memory expansion device to the sub-server to enable the sub-server to use an expanded memory in the target memory expansion device.

2. The memory expansion method according to claim 1, wherein before the receiving a memory application request from a sub-server of the plurality of sub-servers, the method further comprises:
scanning the memory server to acquire first resource information of all of the plurality of memory expansion devices in the memory server; and
creating a resource master table, and adding the first resource information of all of the plurality of memory expansion devices to the resource master table.

3. The memory expansion method according to claim 2, wherein the determining a target memory expansion device among the plurality of memory expansion devices based on a requested memory size in the memory application request comprises:
determining the target memory expansion device among the plurality of memory expansion devices based on the requested memory size in the memory application request and the resource master table.

4. The memory expansion method according to claim 3, wherein after the determining the target memory expansion device among the plurality of memory expansion devices based on the requested memory size in the memory application request and the resource master table, the method further comprises:
deleting the resource information of the target memory expansion device from the resource master table.

5. The memory expansion method according to claim 2, wherein after the sending resource information of the target memory expansion device to the sub-server to enable the sub-server to use an expanded memory in the target memory expansion device, the method further comprises:
receiving a memory release request for releasing the target memory expansion device from the sub-server, and re-adding the resource information of the target memory expansion device to the resource master table.

6. The memory expansion method according to claim 1, wherein each of the expanded memories comprises a plurality of memory blocks with preset sizes, and the determining a target memory expansion device among the plurality of memory expansion devices based on a requested memory size in the memory application request comprises:
determining a target memory block in the target memory expansion device based on the requested memory size in the memory application request.

7. The memory expansion method according to claim 6, wherein the sending resource information of the target memory expansion device to the sub-server to enable the sub-server to use an expanded memory in the target memory expansion device comprises:
sending resource information of the target memory block in the target memory expansion device to the sub-server to enable the sub-server to use the target memory block in the target memory expansion device.

8. The memory expansion method according to claim 1, wherein the plurality of memory expansion devices comprise the expanded memories of different memory types, an expanded memory of each type comprising a plurality of memory blocks with preset sizes; and the determining a target memory expansion device among the plurality of memory expansion devices based on a requested memory size in the memory application request comprising:
determining a target memory block in the target memory expansion device based on the requested memory size and a requested memory type in the memory application request.

9. The memory expansion method according to claim 8, wherein the sending resource information of the target memory expansion device to the sub-server to enable the sub-server to use an expanded memory in the target memory expansion device comprises:
sending resource information of the target memory block in the target memory expansion device to the sub-server to enable the sub-server to use the target memory block in the target memory expansion device.

10. The memory expansion method according to claim 1, wherein the main server is connected to the plurality of sub-servers through network ports, and the sending resource information of the target memory expansion device to the sub-server comprises:
sending the resource information of the target memory expansion device to the sub-server through a network port of the network ports between the main server and the sub-server.

11. The memory expansion method according to claim 1, wherein the plurality of memory expansion devices comprise a compute express link devices.

12. A memory expansion method, being applied to sub-servers in a server system, the server system comprising a plurality of servers and a memory server, the plurality of servers comprising a main server and a plurality of sub-servers, the plurality of servers being connected to the memory server, the memory server comprising a switch and a plurality of memory expansion devices, the plurality of memory expansion devices being connected through the switch, the plurality of memory expansion devices comprising expanded memories, and
the method comprising:
sending a memory application request to the main server, the memory application request comprising a to-be-requested memory size; and
receiving resource information of a target memory expansion device sent by the main server to use an expanded memory in the target memory expansion device.

13. The memory expansion method according to claim 12, wherein using the expanded memory in the target memory expansion device comprises:
creating a resource sub-table, and adding the resource information of the target memory expansion device to the resource sub-table; and
creating a non-uniform memory access node based on the resource information of the target memory expansion device to use the expanded memory in the target memory expansion device.

14. The memory expansion method according to claim 12, wherein after the receiving resource information of a target memory expansion device sent by the main server to use an expanded memory in the target memory expansion device, the method further comprises:
after the expanded memory in the target memory expansion device is used, sending a memory release request for releasing the target memory expansion device to the main server.

15. The memory expansion method according to claim 14, wherein before the sending a memory release request for releasing the target memory expansion device to the main server, the method further comprises:
deleting the resource information of the target memory expansion device from a local resource sub-table.

16. The memory expansion method according to claim 12, wherein the receiving resource information of a target memory expansion device sent by the main server to use an expanded memory in the target memory expansion device comprises:
receiving resource information of a target memory block in the target memory expansion device sent by the main server to use the target memory block in the target memory expansion device.

17. The memory expansion method according to claim 12, wherein the memory application request further comprises a to-be-requested memory type; and the receiving resource information of a target memory expansion device sent by the main server to use an expanded memory in the target memory expansion device comprises:
receiving resource information of a target memory block matching the to-be-requested memory type in the target memory expansion device sent by the main server to use the target memory block in the target memory expansion device.

18.-19. (canceled)

20. A server system, comprising a plurality of servers and a memory server, the servers comprising a main server and a plurality of sub-servers, the plurality of servers being connected to the memory server, the memory server comprising a switch and a plurality of memory expansion devices, the plurality of memory expansion devices being connected to the switch, the plurality of servers being connected to the switch, and the plurality of memory expansion devices comprising an expanded memories.

21.-22. (canceled)

23. The memory expansion method according to claim 1, wherein the plurality of memory expansion devices are Computer Express Link (CXL) devices.

24. The memory expansion method according to claim 8, the expanded memories of different memory types comprise a random access memory (RAM) and a persistent memory (PMEM).
